(19) United States
(12) Patent Application Publication
(10) Pub. No.: US 2025/0225771 A1
(43) Pub. Date: Jul. 10, 2025

(54) IMAGE PROCESSING METHOD, APPARATUS THEREOF, COMPUTER DEVICE AND STORAGE MEDIUM

(71) Applicant: CAPITAL NORMAL UNIVERSITY, Beijing (CN)

(72) Inventors: Zhenzhou SHAO, Beijing (CN); Yong GUAN, Beijing (CN); Ying QU, Beijing (CN); Mingyue LI, Beijing (CN); Chao LIU, Beijing (CN); Zhiping SHI, Beijing (CN); Guohui WANG, Beijing (CN); Yongmei LIU, Beijing (CN)

(73) Assignee: CAPITAL NORMAL UNIVERSITY, Beijing (CN)

(21) Appl. No.: 19/036,062

(22) Filed: Jan. 24, 2025

Related U.S. Application Data
(63) Continuation of application No. PCT/CN2022/109264, filed on Jul. 29, 2022.

(30) Foreign Application Priority Data
Jul. 25, 2022 (CN) 202210884702.5

(51) Int. Cl. G06V 10/771; G06V 10/52; G06V 10/77; G06V 10/776; G06V 10/80; G06V 10/82; G06V 10/98

(52) U.S. Cl. CPC G06V 10/771; G06V 10/7715; G06V 10/776; G06V 10/82; G06V 10/52; G06V 10/806; G06V 10/98

(57) ABSTRACT

An image processing method and apparatus, a computer device, and a storage medium. The method includes: acquiring a first image feature obtained by extracting a first feature from a first image and a second image feature obtained by extracting a second feature from a second image, the image types of the first image and the second image being different (S101); based on the first image feature and the second image feature, determining feature selection weightings respectively corresponding to the first image feature and the second image feature (S102); based on the feature selection weightings respectively corresponding to the first image feature and the second image feature, performing feature fusion on the first image feature and the second image feature to obtain fused feature data (S103); and performing object detection processing based on the fused feature data to obtain an object detection result (S104).

### CROSS-REFERENCE TO THE RELATED APPLICATIONS

This application is the continuation application of International Application No. PCT/CN2022/109264, filed on Jul. 29, 2022, which is based upon and claims priority to Chinese Patent Application No. 202210884702.5, filed on Jul. 25, 2022, the entire contents of which are incorporated herein by reference.

### TECHNICAL FIELD

The present disclosure relates to the technical field of image processing, in particular to an image processing method, an apparatus thereof, a computer device and a storage medium.

### BACKGROUND

When an image is processed, object detection can be performed on the image, and objects such as people, vehicles and animals included therein are determined. Alternatively, the posture and the action of a human body in the image may be identified and detected. In order to obtain more accurate detection results through an image processing method, the quality of the image needs to be high. However, in real scenes, due to the influence of the shooting environment, shooting devices, etc., the acquired images may have quality problems such as unclear display, which can easily lead to inaccurate detection results after image processing.

### SUMMARY

Embodiments of the present disclosure at least provide an image processing method, an apparatus thereof, a computer device and a storage medium.

In a first aspect, the embodiment of the present disclosure provides an image processing method, including: acquiring a first image feature obtained by extracting a first feature from a first image and a second image feature obtained by extracting a second feature from a second image, wherein an image type of the first image is different from that of the second image; determining feature selection weights respectively corresponding to the first image feature and the second image feature based on the first image feature and the second image feature; performing feature fusion on the first image feature and the second image feature based on the feature selection weights respectively corresponding to the first image feature and the second image feature, to obtain fused feature data; and performing object detection processing based on the fused feature data to obtain an object detection result.

In this way, the image features acquired of different image types can complement each other in terms of features through feature fusion. By determining the feature selection weights for different image features, respectively, the unique feature parts of image features for different image types can be fused during feature fusion. In this way, the obtained fused feature data can provide both color features and other features except color features. Therefore, when an image is processed, detection processing can be performed on the features of multiple dimensions in the fused feature data, thus improving the accuracy of the detection result.

In some embodiments, the acquiring a first image feature obtained by extracting a first feature from a first image and a second image feature obtained by extracting a second feature from a second image includes: acquiring the first image and the second image; and for any one of the images, performing convolution processing on the image, and performing squeeze-and-excitation processing on a result obtained after convolution processing to obtain an image feature corresponding to the image.

In some embodiments, the determining feature selection weights respectively corresponding to the first image feature and the second image feature based on the first image feature and the second image feature includes: performing first feature fusion processing on the first image feature and the second image feature to obtain an initial fused feature; determining a feature importance vector for the first image feature and the second image feature based on the initial fused feature; and determining the feature selection weights respectively corresponding to the first image feature and the second image feature by using the feature importance vector.

In this way, the feature selection weight can effectively select each image feature prior to fusing the image features, instead of simply superimposing the features, so that the obtained fused feature data may contain features with more detection advantages in the first image and the second image, thus improving the accuracy of object detection by the fused feature data.

In some embodiments, the determining a feature importance vector for the first image feature and the second image feature based on the initial fused feature includes: performing global pooling processing on the initial fused feature to obtain an intermediate fused feature; performing full connection processing on the intermediate fused feature, and performing normalization processing on the intermediate fused feature after the full connection processing to obtain the feature importance vector.

In some embodiments, the determining the feature selection weights respectively corresponding to the first image feature and the second image feature by using the feature importance vector includes: determining the feature selection weights respectively corresponding to the first image feature and the second image feature based on the feature importance vector, the first image feature and the second image feature.

In some embodiments, the performing feature fusion on the first image feature and the second image feature based on the feature selection weights respectively corresponding to the first image feature and the second image feature, to obtain fused feature data includes: performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and performing second feature fusion processing on the first selected feature data and the second selected feature data to obtain the fused feature data.

In some embodiments, the image processing method is applied to a pre-trained network; and wherein the network includes: a feature encoder, a feature reweighting device, and an object detector; wherein the feature encoder is configured to acquire the first image feature obtained by extracting the first feature from the first image and the second image feature obtained by extracting the second feature from the second image, wherein the image type of the first image is different from that of the second image; the feature reweighting device is configured to determine the feature selection weights respectively corresponding to the first image feature and the second image feature based on the first image feature and the second image feature; and perform the feature fusion on the first image feature and the second image feature based on the feature selection weights respectively corresponding to the first image feature and the second image feature, to obtain fused feature data; and the object detector is configured to perform the object detection processing based on the fused feature data to obtain the object detection result.

In this way, the image processing method can be deployed on a hardware device through the network, which is more suitable for actual applications.

In some embodiments, the feature encoder and the feature reweighting device are obtained by training in following manner: acquiring a first sample image and a second sample image, wherein an image type of the first sample image is different from that of the second sample image; extracting a first feature from the first sample image by using a feature encoder to be trained to obtain a first sample feature; and extracting a second feature from the second sample image by using the feature encoder to be trained to obtain a second sample feature; determining sample feature selection weights respectively corresponding to the first sample feature and the second sample feature by using a feature reweighting device to be trained, and performing the feature fusion on the first sample feature and the second sample feature based on the sample feature selection weights respectively corresponding to the first sample feature and the second sample feature, to obtain sample fused feature data; performing first decoding processing and second decoding processing on the sample fused feature data by using a feature decoder to obtain a first decoded image corresponding to the first sample image and a second decoded image corresponding to the second sample image; determining a feature contrastive loss based on the first sample image, the second sample image, the first decoded image, and the second decoded image; and updating the feature encoder to be trained and the feature reweighting device to be trained based on the feature contrastive loss to obtain the feature encoder and the feature reweighting device.

In some embodiments, the feature contrastive loss includes at least one of a similar feature contrastive loss and a non-similar feature contrastive loss; wherein the similar feature contrastive loss includes at least one of: a first feature contrastive loss of the first sample image and the first decoded image, and a second feature contrastive loss of the second sample image and the second decoded image; and the non-similar feature contrastive loss includes at least one of: a third feature contrastive loss of the first sample image and the second decoded image, and a fourth feature contrastive loss of the second sample image and the first decoded image.

In this way, a cross loss function is selected to balance the sample image and the decoded image, so that the images of one image type among the images of two image types are close to the images of the other image type, thus ensuring that the complementary features in the images of the two image types do not participate in feature fusion, but are well preserved. For the actual application process, the obtained fused feature data will also contain the complementary features in the images of two different image types. For two different images, the complementary features can supplement the defects or deficiencies in their own image types. Therefore, compared to only using images of two different image types for object detection, it is easier to perform object detection accurately.

In a second aspect, the embodiment of the present disclosure further provides an image processing apparatus, including: an acquisition module, configured to acquire a first image feature obtained by extracting a first feature from a first image and a second image feature obtained by extracting a second feature from a second image, wherein an image type of the first image is different from that of the second image; a determining module, configured to determine feature selection weights respectively corresponding to the first image feature and the second image feature based on the first image feature and the second image feature; a feature fusion module, configured to perform feature fusion on the first image feature and the second image feature based on the feature selection weights respectively corresponding to the first image feature and the second image feature, to obtain fused feature data; and a processing module, configured to perform object detection processing based on the fused feature data to obtain an object detection result.

In some embodiments, when acquiring a first image feature obtained by extracting a first feature from a first image and a second image feature obtained by extracting a second feature from a second image, the acquisition module is configured to: acquire the first image and the second image; and for any one of images, perform convolution processing on the image, and perform squeeze-and-excitation processing on a result obtained after convolution processing to obtain an image feature corresponding to the image.

In some embodiments, when determining feature selection weights respectively corresponding to the first image feature and the second image feature based on the first image feature and the second image feature, the determining module is configured to: perform first feature fusion processing on the first image feature and the second image feature to obtain an initial fused feature; determine a feature importance vector for the first image feature and the second image feature based on the initial fused feature; and determine the feature selection weights respectively corresponding to the first image feature and the second image feature by using the feature importance vector.

In some embodiments, when determining feature importance vector for the first image feature and the second image feature based on the initial fused feature, the determining module is configured to: perform global pooling processing on the initial fused feature to obtain an intermediate fused feature; and perform full connection processing on the intermediate fused feature, and perform normalization processing on the intermediate fused feature after the full connection processing to obtain the feature importance vector.

In some embodiments, when determining the feature selection weights respectively corresponding to the first image feature and the second image feature by using the feature importance vector, the determining module is configured to: determine the feature selection weights respectively corresponding to the first image feature and the second image feature based on the feature importance vector, the first image feature and the second image feature.

In some embodiments, when performing feature fusion on the first image feature and the second image feature based on the feature selection weights respectively corresponding to the first image feature and the second image feature to obtain fused feature data, the feature fusion module is configured to: perform feature selection on the first image feature based on a feature selection weight corresponding to the first image feature to obtain first selected feature data of the first image feature; and perform the feature selection on the second image feature by using a feature selection weight corresponding to the second image feature to obtain second selected feature data of the second image feature; and perform second feature fusion processing on the first selected feature data and the second selected feature data to obtain the fused feature data.

In some embodiments, the image processing method is applied to a pre-trained network; and wherein the network includes: a feature encoder, a feature reweighting device, and an object detector; wherein the feature encoder is configured to acquire the first image feature obtained by extracting the first feature from the first image and the second image feature obtained by extracting the second feature from the second image, wherein the image type of the first image is different from that of the second image; the feature reweighting device is configured to determine the feature selection weights respectively corresponding to the first image feature and the second image feature based on the first image feature and the second image feature; and perform the feature fusion on the first image feature and the second image feature based on the feature selection weights respectively corresponding to the first image feature and the second image feature, to obtain the fused feature data; and the object detector is configured to perform the object detection processing based on the fused feature data to obtain the object detection result.

In some embodiments, the feature encoder and the feature reweighting device are obtained by training in the following steps: acquiring a first sample image and a second sample image, wherein an image type of the first sample image is different from that of the second sample image; extracting a first feature from the first sample image by using a feature encoder to be trained to obtain a first sample feature; and extracting a second feature from the second sample image by using the feature encoder to be trained to obtain a second sample feature; determining sample feature selection weights respectively corresponding to the first sample feature and the second sample feature by using a feature reweighting device to be trained, and performing the feature fusion on the first sample feature and the second sample feature based on the sample feature selection weights respectively corresponding to the first sample feature and the second sample feature, to obtain sample fused feature data; performing first decoding processing and second decoding processing on the sample fused feature data by using a feature decoder to obtain a first decoded image corresponding to the first sample image and a second decoded image corresponding to the second sample image; and determining a feature contrastive loss based on the first sample image, the second sample image, the first decoded image, and the second decoded image; and updating the feature encoder to be trained and the feature reweighting device to be trained based on the feature contrastive loss to obtain the feature encoder and the feature reweighting device.

In some embodiments, the feature contrastive loss includes at least one of a similar feature contrastive loss and a non-similar feature contrastive loss; wherein the similar feature contrastive loss includes at least one of: a first feature contrastive loss of the first sample image and the first decoded image, and a second feature contrastive loss of the second sample image and the second decoded image; the non-similar feature contrastive loss includes at least one of: a third feature contrastive loss of the first sample image and the second decoded image, and a fourth feature contrastive loss of the second sample image and the first decoded image.

In a third aspect, some embodiments of the present disclosure further provide a computer device, including a processor and a memory having machine-readable instructions executable by the processor stored therein, wherein the processor is configured to execute the machine-readable instructions stored in the memory, and when the machine-readable instructions are executed by the processor, the processor implements the steps in the first aspect or any one embodiment of the first aspect.

In a fourth aspect, some embodiments of the present disclosure further provide a computer-readable storage medium, having a computer program stored therein, and the computer program, when being run, implements the steps in the first aspect or any one embodiment of the first aspect.

The effects of the image processing apparatus, the computer device, and the computer-readable storage medium described above are described with reference to the description of the above image processing method, which will not be described in detail here.

In order to make the above objects, features and advantages of the present disclosure more obvious and understandable, a detailed description of preferred embodiments is made in conjunction with the drawings hereinafter.

### BRIEF DESCRIPTION OF THE DRAWINGS

In order to explain the technical solutions of the embodiments of the present disclosure more clearly, the drawings needed in the embodiment will be briefly introduced hereinafter, which are incorporated into and constitute a part of this specification. These drawings show the embodiments consistent with the present disclosure and together with the specification, serve to explain the technical solution of the present disclosure. It should be understood that the following drawings only show some embodiments of the present disclosure, which should not be regarded as limiting the scope. For those skilled in the art, other related drawings can be obtained according to these drawings without paying creative labor.

FIG. 1 shows a flowchart of an image processing method according to some embodiments of the present disclosure.

FIG. 2A is a picture showing a first image according to some embodiments of the present disclosure.

FIG. 2B is a picture showing a second image according to some embodiments of the present disclosure.

FIG. 3 is a picture showing an object detection result according to some embodiments of the present disclosure.

FIG. 4 shows a schematic diagram of a network according to some embodiments of the present disclosure.

FIG. 5 shows a schematic structural diagram of a first feature encoder according to some embodiments of the present disclosure.

FIG. 6 shows a schematic structural diagram of a feature encoder according to some embodiments of the present disclosure.

FIG. 7 shows a schematic diagram of a feature reweighting device according to some embodiments of the present disclosure.

FIG. 8 shows a schematic diagram of a feature decoder according to some embodiments of the present disclosure.

FIG. 9 shows a schematic diagram of another network according to some embodiments of the present disclosure.

FIG. 10 shows a schematic diagram of an image processing apparatus according to some embodiments of the present disclosure.

FIG. 11 shows a schematic diagram of a computer device according to some embodiments of the present disclosure.

### DETAILED DESCRIPTION OF THE EMBODIMENTS

In order to make the purpose, the technical solution and the advantages of the embodiments of the present disclosure more clear, the technical solutions in the embodiments of the present disclosure will be described clearly and completely in conjunction with the drawings hereinafter. Obviously, the described embodiments are only some embodiments of the present disclosure, rather than all of the embodiments. The components of the embodiments of the present disclosure generally described and illustrated herein may be arranged and designed in various different configurations. Therefore, the following detailed description of the embodiments of the present disclosure is not intended to limit the scope of the claimed disclosure, but merely represents the selected embodiments of the present disclosure. Based on the embodiments of the present disclosure, all other embodiments obtained by those skilled in the art without paying creative labor belong to the scope of protection of the present disclosure.

Through research, it is found that when an object is detected or the posture and the action of a human body are identified and detected using the image processing method, the quality of the processed image needs to be high. For example, if images acquired by an image acquisition device such as a camera are shot in a shooting environment with insufficient light such as at night or in rainy days, the obtained images will have unclear display problems. Because the image has only a single image feature, and the unclear image will influence the image feature, the image feature cannot be better used for image processing. Such images are prone to having inaccurate detection results after image processing.

Based on the above research, the present disclosure provides an image processing method, an apparatus thereof, a computer device and a storage medium. Different image features are obtained by acquiring images of different image types. The image features acquired of different image types can complement each other in terms of features through feature fusion. By determining the feature selection weights for different image features, respectively, the unique feature parts of image features for different image types can be fused during feature fusion. In this way, the obtained fused feature data can provide both color features and other features except color features. Therefore, when an image is processed, detection processing can be performed on the features of multiple dimensions in the fused feature data, thus improving the accuracy of the detection result.

The defects of the above solution are the results obtained by the inventors through practice and careful study. Thus the discovery process of the above problems and the solutions to the above problems proposed in the present disclosure below should be the contributions made by the inventors to the present disclosure in the process of the present disclosure.

It should be noted that similar reference numbers and letters indicate similar items in the following drawings. Therefore, once an item is defined in one drawing, the item does not need to be further defined and explained in subsequent drawings.

In order to facilitate the understanding of the embodiment, first, an image processing method disclosed in the embodiment of the present disclosure is introduced in detail. The execution subject of the image processing method according to the embodiment of the present disclosure is generally a computer device with certain computing power, which includes, for example, a terminal device or a server or other processing devices. The terminal device may be User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the image processing method can be realized through calling computer-readable instructions stored in the memory by the processor.

The image processing method according to the embodiment of the present disclosure will be described hereinafter. The image processing method according to the embodiment of the present disclosure can be specifically applied to but not limited to the following scenes. A plurality of scenes, for example, include a driving scene. For example, the image processing method is applied to image processing of images acquired in front of vehicles during driving, so as to obtain detection results of various objects (such as pedestrians, other vehicles, obstacles, etc.) in front of vehicles, thus avoiding traffic according to the detection results and ensuring driving safety. Alternatively, the scenes may further include a motion detection scene. For example, in the training process of athletes, the images of athletes in motion are acquired, and the posture and the action of a human body are detected through image processing, so as to guide the adjustment of the motion posture of athletes, achieving a better training effect. Alternatively, the scenes may include an application scene of the virtual reality. The images of the characters in the real scene are acquired, and the actions of the characters are determined through image processing, so that the actions corresponding to the characters in the real scene can be expressed through virtual characters in the constructed virtual scene. The above scenes are only a few possible example scenes, and other scenes that may be subjected to image processing fall within the scope of protection of the embodiment of the present disclosure, which will not be described in detail here.

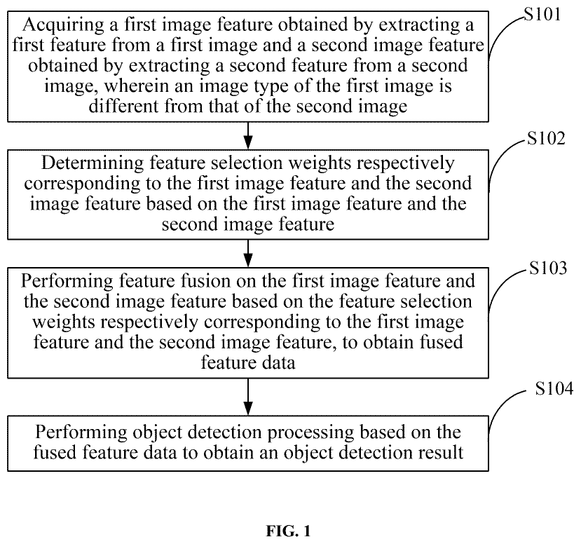

Refer to FIG. 1, which is a flowchart of an image processing method according to an embodiment of the present disclosure. The method includes steps S101-S104.

In step S101, a first image feature obtained by extracting a first feature from a first image and a second image feature obtained by extracting a second feature from a second image are acquired, wherein the image type of the first image is different from that of the second image.

In step S102, feature selection weights respectively corresponding to the first image feature and the second image feature are determined based on the first image feature and the second image feature.

In step S103, feature fusion is performed on the first image feature and the second image feature based on the feature selection weights respectively corresponding to the first image feature and the second image feature, to obtain fused feature data.

In step S104, object detection processing is performed based on the fused feature data to obtain an object detection result.

According to the embodiment of the present disclosure, the first image feature of the first image and the second image feature of the second image are obtained by extracting features of the first image and the second image of different image types, respectively. Thereafter, feature selection weights corresponding to the first image feature and the second image feature, respectively, are determined by using the first image feature and the second image feature, so as to perform feature fusion processing on the first image feature and the second image feature, and perform object detection processing on the fused feature data obtained after fusion processing, thus obtaining an object detection result. When an image is processed, detection processing can be performed on the features of multiple dimensions in the fused feature data, so as to avoid the influence of external factors on the color features of the image when the image is processed only by the color features, thereby improving the accuracy of the detection result obtained after image processing.

Next, taking the driving scene as an example, the above steps S101 to S104 will be described in detail.

For step S101, first, the first image and the second image will be described. Here, the first image and the second image contain at least image information of different image types, respectively. The image information can be used to indicate the image features of the corresponding image types, and the image features of different image types are not exactly the same. The image types described here are different, which specifically indicates that the image information reflected by the two images is different. For example, an image expressed by the color space, such as a Red-Green-Blue (RGB) image, a Hue-Saturation-Value (HSV) image, a Luminance-U-Chrominance-V-Chrominance image, reflects image information including the color information of each pixel point. An image obtained by thermal imaging, such as s thermal infrared image obtained by a thermal imaging acquisition device, reflects image information including thermal infrared radiation information of each object in the image. An image that expresses the position information corresponding to point cloud data through coordinates and depth values, such as a depth image, reflects depth image information including the indicated position information of point cloud points in the three-dimensional space.

In one possible case, the first image and the second image are, for example, acquired raw images of different image types. For example, the first image includes an RGB video frame image acquired by a camera, and the second image includes a thermal infrared image acquired by a thermal imaging acquisition device. In this case, after image processing is performed on the first image and the second image, the fused feature data with image features expressed by color information and image features expressed by thermal infrared radiation information can be obtained. For another example, the first image includes an acquired RGB image, and the second image includes an acquired depth image. In this case, after image processing is performed on the first image and the second image, the fused feature data with image features expressed by color information and image features expressed by depth image information can be obtained.

That is, if the first image and the second image only contain the image information of one image type, the fused feature data obtained after image processing will correspondingly contain the image information of two image types, that is, the image features of two different image types are fused.

In another possible case, there may be at least one image in the first image and the second image, and the corresponding image features have fused the image features of two or more different image types. For example, the first image includes an acquired RGB image, and the second image includes a fused feature image that fuses image features expressed by thermal infrared radiation information and image features expressed by depth image information. In this case, after image processing of the first image and the second image, the fused feature data with three image features, that is, image features expressed by color information, image features expressed by thermal infrared radiation information, and image features expressed by depth image information can be obtained. That is, the fused feature data with more image features of different image types can be obtained compared with the image processing method using the acquired raw images of two different image types. Because the fused feature data may include image features of different image types, there are more features that can be used for detection when performing object detection processing, so that the accuracy of object detection processing can be further improved.

In addition, according to the above example, if the first image and/or the second image have fused feature images with image features of different image types, since the method of obtaining the fused feature image is usually based on the method of performing feature fusion on the images acquired of two different image types, when acquiring the fused feature image as the first image and/or the second image, the image processing method according to the embodiment of the present disclosure can also be used to complete the feature fusion of the two images. For another example, images of three or more different image types can be directly processed to obtain fused feature data with image features of three or more different image types.

Specifically, an appropriate way can be selected for image processing according to the actual situation. For example, when there are images of three image types, the images of two image types can be taken as the first image and the second image, and feature fusion is performed on the second image feature and the first image feature of the first image using the image processing method according to the embodiment of the present disclosure. Thereafter, after the fused feature image of the first image and the second image is determined by using the obtained fused feature data, the fused feature image is taken as a new first image, and the image in the third image type that has not been processed is taken as a new second image, and is processed by the processing method according to the embodiment of the present disclosure. Alternatively, if the images of three different image types are directly processed, in the step of acquiring image features, it will be determined to extract the features of the three images, so as to perform feature fusion on the obtained different images. Here, the selection method is not limited, and different methods of processing the images of various image types through feature fusion are all within the scope of protection of the embodiment of the present disclosure.

For the convenience of description, the following description is given by taking, as an example, that the first image and the second image are images respectively having image features of only one image type. Only one possible example is listed here, and the specific image types and the included image features of the first image and the second image are not defined.

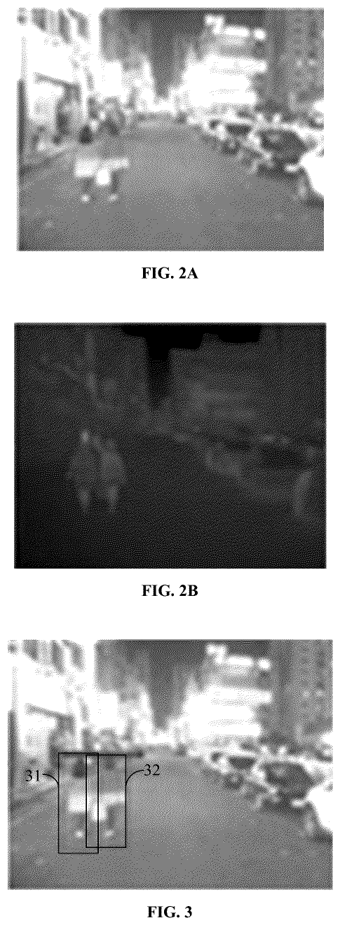

For example, refer to FIGS. 2A-2B, which are pictures showing a first image and a second image according to an embodiment of the present disclosure. The first image is an RGB image, which can be shot by an image acquisition device such as a camera and an automobile data recorder, as shown in FIG. 2A, for example. The second image is a thermal image, which can be acquired by a thermal imager, for example, as shown in FIG. 2B. For the motion detection scene, a high-speed camera and a thermal imager may be set up to shoot the athletes, thereby obtaining a first image of an RGB image type and a second image of a thermal image type.

For the area where images are acquired, such as the area in front of a vehicle described above, in one possible case, in order to perform feature fusion better when processing images in the following steps, the image acquisition device and the thermal imager can be made to shoot at the same viewing angle. Alternatively, in the case of different viewing angles, the viewing angle of the image can be adjusted by performing perspective operations on the image. In another possible case, the RGB image and the thermal image obtained at different viewing angles can also be directly used as the first image and the second image, respectively. Here, in the pictures shown in FIGS. 2A-2B, the RGB image and the thermal image shot at different viewing angles are specifically shown.

As can be seen from FIGS. 2A-2B, the first image corresponding to the RGB image can clearly display various objects in the area in front of the vehicle, including pedestrians in front and vehicles and buildings on the side. However, in the dark environment, due to the dim light and the lighting influence of surrounding buildings, it is not easy to distinguish pedestrians on the road ahead in the first image from other objects to determine the accurate position. In the second image corresponding to the thermal image, because the temperature is less affected by light, a plurality of objects can be clearly distinguished in the image. Therefore, it is beneficial to determine the area where objects exist when processing images, but compared with the first image, it is not easy to judge and determine the classification of objects. Therefore, in processing images through the first image and the second image to perform object detection, specifically, object detection can be performed by performing the feature fusion on the features of the first image and the features of the second image, so as to effectively utilize the feature advantages of different image types, that is, the image features that are possessed by the images of one image type but not possessed or obviously expressed by the images of another image type are fused, so as to process images more accurately by using the fused feature data.

Specifically, the first image feature of the first image and the second image feature of the second image can be obtained by extracting features from the first image and the second image. Because the image type of the first image is different from that of the second image, the parameters selected during feature extraction are different. Therefore, the method of extracting a feature from the first image is referred to as the first feature extraction, and the method of extracting a feature from the second image is referred to as the second feature extraction.

In a specific implementation, in acquiring a first image feature obtained by extracting a first feature from a first image and a second image feature obtained by extracting a second feature from a second image, the following methods can be used: acquiring the first image and the second image; and for any one of the images, performing convolution processing on the image, and performing squeeze-and-excitation processing on a result obtained after convolution processing to obtain an image feature corresponding to the image.

A first image feature is obtained by extracting a first feature from a first image, which is taken as an example. In performing convolution processing on the first image, for example, convolution kernels with dimensions (in pixels) of 1×1 and 3×3 can be used to perform convolution processing on the first image successively to obtain the intermediate image feature corresponding to the first image, that is, the result obtained after convolution processing. For the result obtained after convolution processing, the first image feature can be obtained by squeeze-and-excitation. Squeeze-and-excitation specifically includes performing global pooling and full connection operations on the result obtained after convolution processing, so as to select the first image feature of the first image from the intermediate image feature obtained after convolution through multiplication operation.

The method of extracting the second feature from the second image is the same as the method of extracting the first feature from the first image, but the parameters can be adjusted accordingly according to different image types, so as to acquire an effective second image feature from the second image, which will not be described in detail here.

In this way, for the first image and the second image of different image types, the first image feature of the first image and the second image feature of the second image can be acquired.

For step S102 above, in performing feature fusion on the first image feature and the second image feature which are obtained, the corresponding feature selection weights can be specifically determined, thus effectively selecting the feature prior to fusing the features, instead of simply superimposing the features. In this way, the obtained feature fusion result, that is, the fused feature data described below, may contain features with more detection advantages in the first image and the second image, thus improving the accuracy of object detection by the fused feature data.

In a specific implementation, in determining feature selection weights respectively corresponding to the first image feature and the second image feature based on the first image feature and the second image feature, the following methods can be used: performing first feature fusion processing on the first image feature and the second image feature to obtain an initial fused feature; determining a feature importance vector for the first image feature and the second image feature based on the initial fused feature; and determining the feature selection weights respectively corresponding to the first image feature and the second image feature by using the feature importance vector.

For example, for convenience of description, the first image feature is denoted as U₁, and the second image feature is denoted as U₂. After first feature fusion processing is performed on the first image feature and the second image feature, the obtained initial fused feature U can be expressed by the following formula (1), for example:

$$U = {U}_{1} + {U}_{2} \qquad ( 1 )$$

Here, both the first image feature U₁ and the second image feature U₂ express the image features under a plurality of channels. Therefore, when first feature fusion processing is performed, the corresponding feature fusion processing is specifically performed for each channel. For example, the number of channels of the first image feature U₁ and the number of channels of the second image feature U₂ are both C. Therefore, the obtained initial fused feature U also corresponds to C channels.

When the initial fused feature U is obtained, the feature importance vector Z can be determined for the first image feature U₁ and the second image feature U₂.

Specifically, global pooling processing is performed on the initial fused features to obtain an intermediate fused feature; then full connection processing is performed on the intermediate fused feature, and normalization processing is performed on the intermediate fused feature after full connection processing to obtain the feature importance vector.

After global pooling processing is performed on the initial fused features, for example, the intermediate fused features with the dimension of 1×1×C can be obtained. Full connection processing and normalization processing are performed on the intermediate fused features to obtain the feature importance vector Z with the dimension of 1×1×C. Here, normalization processing specifically includes, for example, a softmax operation.

The obtained feature importance vector Z can be used to determine the feature selection weights corresponding to the first image feature U₁ and the second image feature U₂. Specifically, the feature importance vector Z is used to determine the corresponding feature selection weights for the first image feature and the second image feature.

Since the first image feature U₁ and the second image feature U₂ both include C channels, the corresponding feature selection weights are determined with the channel as the smallest unit. For convenience of explanation, the c-th channel of the C channels contained in the first image feature U₁ is denoted as U₁^{c}, and the corresponding feature selection weight is denoted as a_{c}; the c-th channel in the second image feature U₂ is denoted as U₂^{c}, and the corresponding feature selection weight is denoted as b_{c}.

Here, the feature selection weight a_{c} corresponding to the first image feature U₁ and the feature selection weight b_{c} corresponding to the second image feature U₂ specifically satisfy the following formula (2):

$$\{ \begin{matrix}{a}_{c} = \frac{{e}^{{U}_{1}^{c} Z}}{{e}^{{U}_{1}^{c} Z} + {e}^{{U}_{2}^{c} Z}} \\ {b}_{c} = \frac{{e}^{{U}_{2}^{c} Z}}{{e}^{{U}_{1}^{c} Z} + {e}^{{U}_{2}^{c} Z}} \\ {a}_{c} + {b}_{c} = 1\end{matrix} \qquad ( 2 )$$

Here, for different image features, the feature importance vector is used to influence the weights, and the corresponding feature selection weights can be obtained. Because of the intervention by the feature importance vector and taking into account two different image features, the obtained feature selection weight can select the part with more feature advantages in the image feature when selecting the image feature in the subsequent step, so as to facilitate the detection and analysis of the more significant features when processing an image in the subsequent step.

For step S103, when determining the feature selection weights respectively corresponding to the first image feature and the second image feature according to the above steps, feature fusion is performed on the first image feature and the second image feature based on the feature selection weights respectively corresponding to the first image feature and the second image feature, to obtain fused feature data

In a specific implementation, feature selection can be performed on the first image feature based on the feature selection weight corresponding to the first image feature to obtain first selected feature data of the first image feature; and feature selection can be performed on the second image feature by using the feature selection weight corresponding to the second image feature to obtain second selected feature data of the second image feature; and second feature fusion processing can be performed on the first selected feature data and the second selected feature data to obtain the fused feature data.

Continuing the above example, for the c-th channel, after performing feature selection on the first image feature U₁^{c} based on the feature selection weight a_{c} corresponding to the first image feature, the first selected feature data U_{1-c} obtained can be expressed by the following formula (3):

$${U}_{1 - c} = {a}_{c} \cdot {U}_{1}^{c} \qquad ( 3 )$$

Similarly, for the c-th channel, after performing feature selection on the second image feature U₂^{c} based on the feature selection weight b_{c} corresponding to the second image feature, the second selected feature data U_{2-c} obtained can be expressed by the following formula (4):

$${U}_{2 - C} = {a}_{c} \cdot {U}_{2}^{c} \qquad ( 4 )$$

The point multiplication operator “.” here means selecting features.

Thereafter, when the first selected feature data U_{1-c} and the second selected feature data U_{2-c} are used to perform second feature fusion processing to obtain fused feature data U_{Fuse-c}, the fused feature data U_{Fuse-c} satisfies the following formula (5):

$${U}_{F u s e - c} = {U}_{1 - c} + {U}_{2 - C} \qquad ( 5 )$$

Here, similar to the above first feature fusion processing method, during the second feature fusion processing, feature fusion is performed based on each channel, in which the specific method is not described in detail here.

In this way, the fused feature data can be obtained after performing feature fusion on the image features respectively corresponding to the first image and the second image.

For step S104 above, because the fused feature data obtained through the above steps can retain the parts with feature advantages in the first image and the second image, that is, the fused feature data has complementary information of two different image types, object detection processing is performed using the fused feature data to obtain an object detection result. Because the fused feature data can have different features in the first image and the second image of different image types, it is easier to perform object detection accurately by the fused feature data, so as to obtain more accurate object detection results.

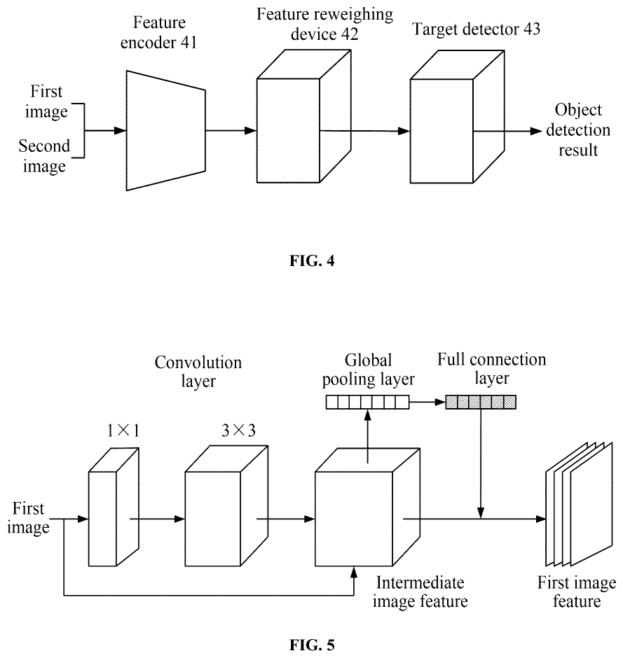

For example, refer to FIG. 3, which is a picture showing an object detection result according to an embodiment of the present disclosure. Specifically, the fused feature data is used, so that for example, a labeling result of an object in the first image and/or the second image can be obtained as an object detection result. In this case, the object detection result includes, but is not limited to, category information and position information of the object. In FIG. 3, two objects with the object category of pedestrians are labeled in the form of a label box 31 and a label box 32, and the labeling information can reflect the current positions of the two pedestrians.

Further, due to the image processing method according to the embodiment of the present disclosure, the obtained object detection result can be more accurate. Therefore, in different scenes, the object detection result can also be used for further processing such as prompt and control, so as to achieve corresponding different functions in different scenes.

For example, in the driving scene, the object detection result can be used to remind, alarm and control the safe driving of vehicles. For example, when the object detection result indicates that there are pedestrians in front of the vehicle, the driver can be reminded to avoid pedestrians by reminding or alarming, or the autonomous vehicle can be controlled to avoid pedestrians by generating corresponding control information. Because the object detection result is more accurate, the further generated prompt information or control information is also more accurate, which can effectively ensure the driving safety of vehicles. Alternatively, in the motion detection scene, the object detection result can be used to guide the current training process of athletes. For example, when the object detection result indicates that the current action of an athlete poses a risk of athletic injury, the athlete can be informed to adjust the action through prompt information to assist the athlete in conducting safe and regular action training. Alternatively, in the application scene of virtual reality, the virtual characters in the virtual scene can be controlled by using the object detection result. For example, if the object detection result indicates that the characters in the real scene are moving forward, the action information reflected by the object detection result can be used to generate action control instructions for the virtual characters in the virtual scene, so as to control the virtual characters to complete the forward actions accordingly, thus realizing the synchronization of the actions of the virtual characters and the characters in the real scene and achieving the effect of controlling the virtual characters by the characters in the real scene.

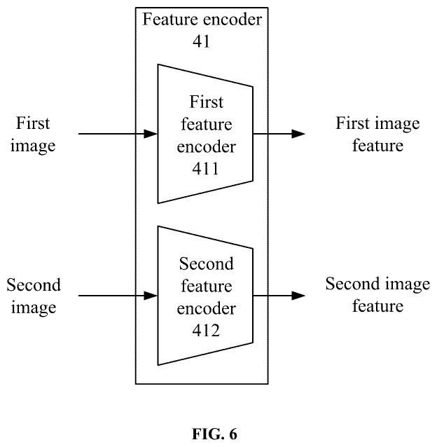

In another embodiment of the present disclosure, in deploying the image processing method according to the embodiment of the present disclosure on a hardware device to deploy on vehicles, motion capture devices and other devices by using the hardware device, the image processing method can be performed by applying the image processing method to a pre-trained network and deploying the network on the hardware device. The network specifically includes a feature encoder, a feature reweighting device, and an object detector, which correspondingly completes a plurality of processing steps in the above embodiment. Specifically, refer to FIG. 4, which is a schematic diagram of a network according to an embodiment of the present disclosure.

The feature encoder 41 is configured to acquire a first image feature obtained by extracting a first feature from a first image and a second image feature obtained by extracting a second feature from a second image, wherein the image type of the first image is different from that of the second image.

The feature reweighting device 42 is configured to determine feature selection weights respectively corresponding to the first image feature and the second image feature based on the first image feature and the second image feature; and perform feature fusion on the first image feature and the second image feature based on the feature selection weights respectively corresponding to the first image feature and the second image feature, to obtain fused feature data.

The object detector 43 is configured to perform object detection processing based on the fused feature data to obtain an object detection result.

In a possible case, if image processing is performed on a first image and a second image with image information of different image types, the feature encoder 41 includes, for example, a first feature encoder which is configured to extract the first feature from the first image and a second feature encoder which is configured to extract the second feature from the second image. In another possible case, if image processing is performed on a plurality of images of different image types, the feature encoder 41 further includes feature encoders corresponding to a plurality of images of different types.

For convenience of explanation, in the following embodiment, the method of performing image processing on two images with image information of different image types is still taken as an example, and the feature encoder 41 includes a first feature encoder and a second feature encoder. The first feature encoder is taken as an example. For example, refer to FIG. 5, which is a schematic structural diagram of a first feature encoder according to an embodiment of the present disclosure.

For the first feature encoder, You Only Look Once version 3 (YOLOv3) can be applied as the backbone network. The residual structure can be used to improve the efficiency of extracting the first feature from the first image and alleviate the over-fitting problem resulted from the deepening of the network. In a process that the first feature encoder processes the first image to obtain the first image feature, the first feature encoder first passes through a convolution layer containing two convolution kernels with different dimensions, and performs convolution processing on the first image to obtain an intermediate image feature. Thereafter, the intermediate image feature is subjected to squeeze-and-excitation processing through Squeeze-and-Exclusion Networks (SENet) including a global pooling layer and a full connection layer to obtain the first image feature.

For the second feature encoder, the used network structure is similar to that of the first feature encoder, but the specific network parameters are different. Therefore, in this case, the specific structure of the feature encoder is shown in FIG. 6, for example, which includes a first feature encoder 411 and a second feature encoder 412 with similar network structures. The first feature encoder 411 and the second feature encoder 412 process the first image and the second image, respectively. Refer to the corresponding description above for the specific process, which will not be described in detail here.

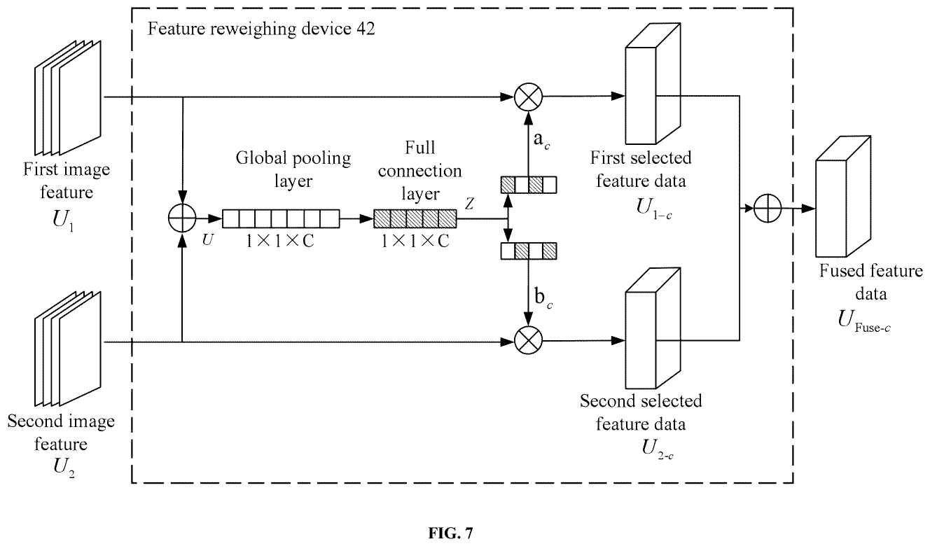

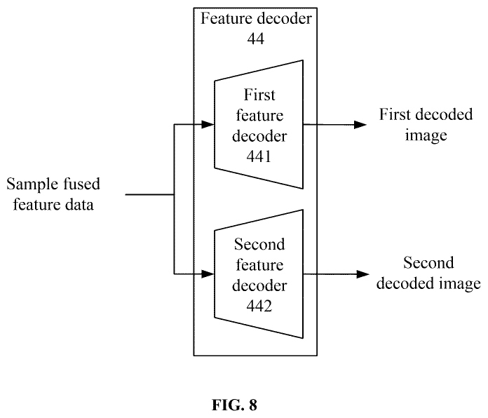

For the feature reweighting device 42, refer to FIG. 7, which is a schematic diagram of a feature reweighting device according to an embodiment of the present disclosure. The input data of the feature reweighting device 42 is the first image feature and the second image feature. After first feature fusion processing is performed on the first image feature U₁ and the second image feature U₂ using an adder (indicated by the symbol “⊗” in FIG. 7) to obtain an initial fused feature U. Thereafter, for the initial fused feature U, the feature importance vector Z is obtained through the processing of the global pooling layer and the full connection layer. The feature importance vector Z is used to determine the feature selection weight a_{c} under the c-th channel for the first image feature U₁ and the feature selection weight b_{c} under the c-th channel for the second image feature U₂.

For the c-th channel, feature selection is performed on the first image feature U₁^{c} by the feature selection weight a_{c} using a multiplier (indicated by the symbol “⊗” in FIG. 7) to obtain first selected feature data U_{1-c}. Similarly, feature selection is performed on the second image feature U₂^{c} by the feature selection weight b_{c} using another multiplier to obtain second selected feature data U_{2-c}. Here, two multipliers are used to perform feature selection processing, which can realize synchronous processing and improve the efficiency of feature selection.

After the first selected feature data U_{1-c} and the second selected feature data U_{2-c} are obtained, second feature fusion processing can be performed using an adder to obtain fused feature data U_{Fuse-c}.

Here, the feature reweighting device 42 processes the first image feature and the second image feature to obtain a detailed description of the fused feature data, and can refer to the description of the corresponding part above, which will not be described in detail here.

The object detector 43 can be specifically constructed by a backbone network such as a convolutional neural network, and undertake the task of performing object detection by using the fused feature data. Here, the specific task of object detection is different in different scenes. Therefore, when it is determined to use the fused feature data for object detection, the specific task of object detection actually performed by the object detector 43 is determined according to the actual application scene. For example, in the driving scene, the object detection task can specifically include performing the classification detection of objects such as pedestrians, other vehicles, and obstacles, and determining the position of each object, such as obtaining the label box of each object in the image. In the motion detection scene, the object detection task can specifically include performing the posture detection and/or action detection on the characters in the motion detection scene to determine whether the actions of the characters are standardized. In the application scene of virtual reality, the object detection task can specifically include performing the action detection on the characters in the real scene to obtain action information.

In addition, because the specific tasks performed by the object detector 43 are different in different scenes, the object detectors 43 selected in different scenes are also different according to the specific tasks. The difference described here includes but is not limited to the difference of network types and the difference of network parameters used in the same network.

Since the object detector 43 specifically performs object detection by the fused feature data, the object detector 43 can be trained through the obtained stable and accurate fused feature data after training the feature encoder 41 and the feature reweighting device 42. Alternatively, the object detector 43 can also perform joint training with the feature encoder 41 and the feature reweighting device 42, and these two training methods are not limited in the embodiment of the present disclosure.

Here, if the method in which the object detector 43 performs joint training with the feature encoder 41 and the feature reweighting device 42 is selected, an “end-to-end” model can be obtained, so that the object detector 43 can be more suitable for processing the fused feature data output by the feature reweighting device 42, that is, the object detector 43 can be more suitable for the features of the fused feature data output by the feature reweighting device 42. In this way, the accuracy of the object detection result obtained after the object detector 43 performs data processing on the fused feature data can be further improved.

The method of training the feature encoder 41 and the feature reweighting device 42 will be described as an example. In a specific implementation, the following Step A1 to Step A5 can be used to train the feature encoder 41 and the feature reweighting device 42.

A1, a first sample image and a second sample image are acquired, wherein the image type of the first sample image is different from that of the second sample image.

Here, when selecting the first sample image and the second sample image, the first sample image and the second sample image corresponding to the two image types can be selected according to the image types corresponding to the first image and the second image selected in the actual application scene. For example, in the above example, the first image is an RGB image expressed by the color space, and the second image is a thermal image acquired by thermal imaging. Therefore, the RGB image can be selected for the first sample image, and the thermal image can be selected for the second sample image. In addition, the first sample image and the second sample image can select images shot at the same viewing angle, that is, images aligned on the displayed screen. Alternatively, corresponding labels are provided when the viewing angles are different, so that the network can learn the image feature purposefully during training to improve the detection ability.

Here, in different application scenes, the labels are also different. For example, for a sample image for training in the driving scene, the corresponding label includes, for example, a label box for each object contained in the sample image. For the sample image for training in the motion detection scene, the corresponding label can be, for example, the position of a key point of the human body corresponding to the human body contained in the sample image and the corresponding action information.

A2, a first feature is extracted from the first sample image by using the feature encoder to be trained to obtain a first sample feature; and a second feature is extracted from the second sample image by using the feature encoder to be trained to obtain a second sample feature.

Here, the specific methods of using the feature encoder to be trained to extract the first feature and the second feature are similar to the processes of using the feature encoder to extract the first feature from the first image and extract the second feature from the second image described in the above embodiments, which will not be described in detail here.

A3, sample feature selection weights respectively corresponding to the first sample feature and the second sample feature are determined by using the feature reweighting device to be trained, and feature fusion is performed on the first sample feature and the second sample feature based on the sample feature selection weights respectively corresponding to the first sample feature and the second sample feature, to obtain sample fused feature data.

Here, the method of using the feature reweighting device to be trained to perform feature fusion on the first sample feature and the second sample feature to determine the sample fused feature data is similar to the method of using the feature reweighting device to perform feature fusion on the first image feature and the second image feature to obtain the fused feature data as described in the above embodiment, which will not be described in detail here.

A4, first decoding processing and second decoding processing are performed on the sample fused feature data by using a feature decoder to obtain a first decoded image corresponding to the first sample image and a second decoded image corresponding to the second sample image.

Here, the feature decoder specifically consists of a deconvolution layer and an upsampling layer. The feature decoder may be pre-trained or used as a feature decoder to be trained in this process, and is trained together with the feature encoder to be trained and the feature reweighting device to be trained.

Corresponding to the above feature encoder 41, in a possible case, if image processing is performed on a first image and a second image with image information of different image types, the feature encoder 41 includes a first feature encoder 411 and a second feature encoder 412, and the corresponding feature decoder includes a first feature decoder and a second feature decoder. In another possible case, if image processing is performed on a plurality of images of different image types, the feature encoder 41 correspondingly includes feature encoders corresponding to a plurality of images of different types. The feature decoder correspondingly includes feature decoders corresponding to a plurality of images of different types.

For convenience of explanation, in the following embodiment, the method of performing image processing on two images with image information of different image types is still taken as an example, and the feature decoder includes a first feature decoder and a second feature decoder. Refer to FIG. 8, which is a schematic diagram of a feature decoder according to an embodiment of the present disclosure. The feature decoder 44 includes a first feature decoder 441 and a second feature decoder 442. The first feature decoder 441 decodes the sample fused feature data to be “restored” to the first decoded image corresponding to the image type of the first sample image. Correspondingly, the second feature decoder 442 decodes the sample fused feature data to obtain a second decoded image corresponding to the image type of the second sample image. That is, the network parameter corresponding to the first feature decoder 441 is different that of the second feature decoder 442.

A5, a feature contrastive loss is determined based on the first sample image, the second sample image, the first decoded image, and the second decoded image; and the feature encoder to be trained and the feature reweighting device to be trained are updated based on the feature contrastive loss to obtain the feature encoder and the feature reweighting device.

The feature contrastive loss includes at least one of: a similar feature contrastive loss and a non-similar feature contrastive loss. The similar feature contrastive loss includes at least one of: a first feature contrastive loss of the first sample image and the first decoded image, and a second feature contrastive loss of the second sample image and the second decoded image; and the non-similar feature contrastive loss includes at least one of: a third feature contrastive loss of the first sample image and the second decoded image, and a fourth feature contrastive loss of the second sample image and the first decoded image.

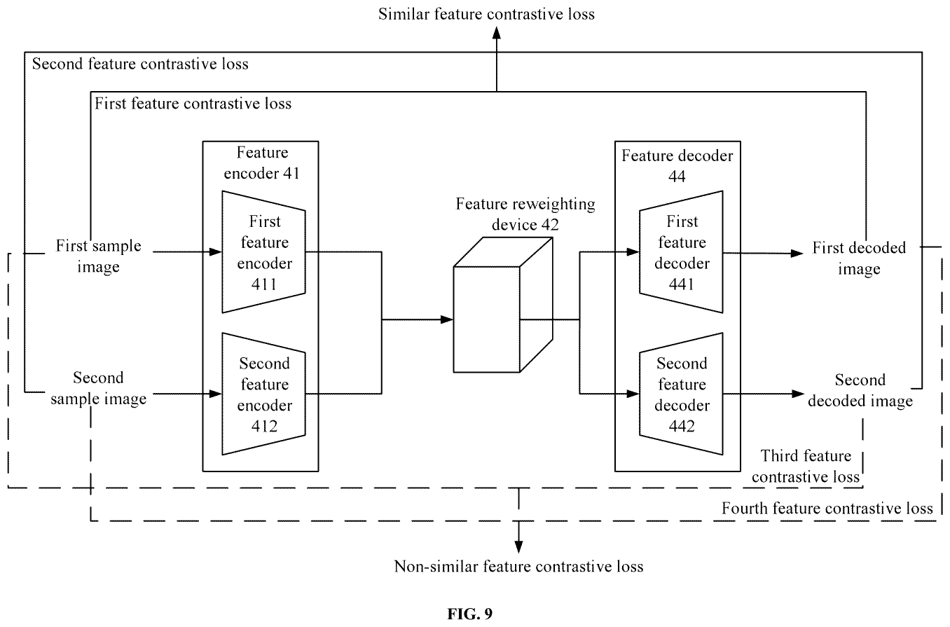

For convenience of explanation, refer to FIG. 9, which is a schematic diagram of another network according to an embodiment of the present disclosure. This network is used for training various parts in the network. This network includes the feature encoder 41, the feature reweighting device 42 and the feature decoder 44 described above, in which the labels of data and some network structures are omitted. In a process of determining the feature contrastive loss, the first feature contrastive loss can be determined by the first sample image and the first decoded image of the same image type, and the second feature contrastive loss can be determined by the second sample image and the second decoded image of the same image type, which are shown by solid lines in the figure. Because the first feature contrastive loss and the second feature contrastive loss are determined according to images of the same image type, these two feature contrastive losses can be combined into similar feature contrastive losses.

Similarly, the third feature contrastive loss can be determined by the first sample image and the second decoded image of different image types, and the fourth feature contrastive loss can be determined by the second sample image and the first decoded image of different image types, which are shown by dotted lines in the figure. Because the third feature contrastive loss and the fourth feature contrastive loss are determined according to images of different image types, these two feature contrastive losses can be combined into non-similar feature contrastive losses.

In a specific implementation, the feature contrastive loss can be determined by calculating the Mean-Square Error (MSE). Specifically, the first feature contrastive loss L_{1_1′}, the second feature contrastive loss L_{2_2′}, the third feature contrastive loss L_{1_2′} and the fourth feature contrastive loss L_{2_1′} obtained satisfy the following formula (6):

$$\{ \begin{matrix}{L}_{1 \_ {1}^{′}} = M SE ( 1 , {1}^{′} ) \\ {L}_{2 \_ {2}^{′}} = M S E ( 2 , {2}^{′} ) \\ {L}_{1 \_ {2}^{′}} = M SE ( 1 , {2}^{′} ) \\ {L}_{2 \_ {1}^{′}} = M S E ( 2 , {1}^{′} )\end{matrix} \qquad ( 6 )$$

For convenience of expression, in the formula, “1” corresponds to the first sample image, “2” corresponds to the second sample image, “1′” corresponds to the first decoded image, and “2′” corresponds to the second decoded image.

Here, a cross loss function is selected to balance the sample image and the decoded image, so that the images of one image type among the images of two image types are close to the images of the other image type. In this way, less feature contrastive loss is also obtained when calculating the loss. If less feature contrastive loss is obtained when calculating the loss, it means that most of the features expressed in the obtained sample fused feature data only correspond to one image type, which means that when the sample fused feature is obtained, the complementary features in the images of the two image types do not participate in feature fusion, but are well preserved. For the actual application process, the obtained fused feature data will also contain the complementary features in the images of two different image types. For two different images, the complementary features can supplement the defects or deficiencies in their own image types. Therefore, it is easier to perform object detection accurately than the method of only using images of two different image types.

When the feature encoder to be trained and the feature reweighting device to be trained are updated by using the feature contrastive loss, the updating direction is the direction to reduce the feature contrastive loss. In a specific implementation, the feature contrastive loss L can specifically satisfy the following formula (7):

$$L = {L}_{1 \_ {1}^{′}} + {L}_{2 \_ {2}^{′}} + {L}_{1 \_ {2}^{′}} + {L}_{2 \_ {1}^{′}} \qquad ( 7 )$$

Specifically, a stochastic gradient descent algorithm can be used to minimize the feature contrastive loss L, so as to obtain a feature encoder and a feature reweighting device with the minimum feature contrastive loss L, or obtain a feature decoder to complete the process of training the structure in the network.

In this way, the feature encoder and the feature reweighting device obtained after training can be applied to the network shown in FIG. 4, so as to perform image processing on the first image and the second image acquired in the actual application and obtain a more accurate object detection result.

It can be understood by those skilled in the art that in the above method of the detailed description, the order in which the steps are written does not imply a strict execution order and does not impose any restrictions on the implementation process. The specific execution order of each step should be determined according to the function and the possible internal logic thereof.

Based on the same inventive concept, the embodiment of the present disclosure further provides an image processing apparatus corresponding to the image processing method. Since the principle of solving problems by the apparatus in the embodiment of the present disclosure is similar to the above image processing method in the embodiment of the present disclosure, the implementation of the apparatus can refer to the implementation of the method, and the repeated parts will not be described here.

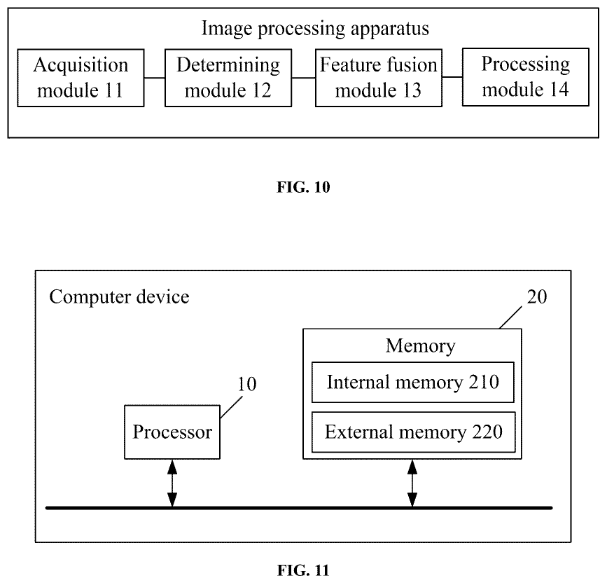

Refer to FIG. 10, which is a schematic diagram of an image processing apparatus according to an embodiment of the present disclosure. The apparatus includes an acquisition module 11, a determining module 12, a feature fusion module 13 and a processing module 14.

The acquisition module 11 is configured to acquire a first image feature obtained by extracting a first feature from a first image and a second image feature obtained by extracting a second feature from a second image, wherein the image type of the first image is different from that of the second image.

The determining module 12 is configured to determine feature selection weights respectively corresponding to the first image feature and the second image feature based on the first image feature and the second image feature.

The feature fusion module 13 is configured to perform feature fusion on the first image feature and the second image feature based on the feature selection weights respectively corresponding to the first image feature and the second image feature, to obtain fused feature data.

The processing module 14 is configured to perform object detection processing based on the fused feature data to obtain an object detection result.

In some embodiments, when acquiring a first image feature obtained by extracting a first feature from a first image and a second image feature obtained by extracting a second feature from a second image, the acquisition module 11 is configured to: acquire the first image and the second image; and for any one of the images, perform convolution processing on the image, and perform squeeze-and-excitation processing on a result obtained after convolution processing to obtain an image feature corresponding to the image.

In some embodiments, when determining feature selection weights respectively corresponding to the first image feature and the second image feature based on the first image feature and the second image feature, the determining module 12 is configured to: perform first feature fusion processing on the first image feature and the second image feature to obtain an initial fused feature; determine a feature importance vector for the first image feature and the second image feature based on the initial fused feature; and determine the feature selection weights respectively corresponding to the first image feature and the second image feature by using the feature importance vector.

In some embodiments, when determining a feature importance vector for the first image feature and the second image feature based on the initial fused feature, the determining module 12 is configured to: perform global pooling processing on the initial fused features to obtain an intermediate fused feature; and perform full connection processing on the intermediate fused feature, and perform normalization processing on the intermediate fused feature after full connection processing to obtain the feature importance vector.

In some embodiments, when determining the feature selection weights respectively corresponding to the first image feature and the second image feature by using the feature importance vector, the determining module 12 is configured to: determine the feature selection weights respectively corresponding to the first image feature and the second image feature based on the feature importance vector, the first image feature and the second image feature.

In some embodiments, when performing feature fusion on the first image feature and the second image feature based on the feature selection weights respectively corresponding to the first image feature and the second image feature to obtain fused feature data, the feature fusion module 13 is configured to: perform feature selection on the first image feature based on the feature selection weight corresponding to the first image feature to obtain first selected feature data of the first image feature; and perform feature selection on the second image feature by using the feature selection weight corresponding to the second image feature to obtain second selected feature data of the second image feature; and perform second feature fusion processing on the first selected feature data and the second selected feature data to obtain the fused feature data.

In some embodiments, the image processing method is applied to a pre-trained network; and wherein the network includes: a feature encoder, a feature reweighting device, and an object detector; wherein the feature encoder is configured to acquire a first image feature obtained by extracting a first feature from a first image and a second image feature obtained by extracting a second feature from a second image, wherein the image type of the first image is different from that of the second image; the feature reweighting device is configured to determine feature selection weights respectively corresponding to the first image feature and the second image feature based on the first image feature and the second image feature; and perform feature fusion on the first image feature and the second image feature based on the feature selection weights respectively corresponding to the first image feature and the second image feature, to obtain fused feature data; and the object detector is configured to perform object detection processing based on the fused feature data to obtain an object detection result.

In some embodiments, the feature encoder and the feature reweighting device are obtained by training in the following manner: acquiring a first sample image and a second sample image, wherein the image type of the first sample image is different from that of the second sample image; extracting a first feature from the first sample image by using the feature encoder to be trained to obtain a first sample feature; and extracting a second feature from the second sample image by using the feature encoder to be trained to obtain a second sample feature; determining sample feature selection weights respectively corresponding to the first sample feature and the second sample feature by using the feature reweighting device to be trained, and performing feature fusion on the first sample feature and the second sample feature based on the sample feature selection weights respectively corresponding to the first sample feature and the second sample feature, to obtain sample fused feature data; performing first decoding processing and second decoding processing on the sample fused feature data by using a feature decoder to obtain a first decoded image corresponding to the first sample image and a second decoded image corresponding to the second sample image; and determining a feature contrastive loss based on the first sample image, the second sample image, the first decoded image, and the second decoded image; and updating the feature encoder to be trained and the feature reweighting device to be trained based on the feature contrastive loss to obtain the feature encoder and the feature reweighting device.

In some embodiments, the feature contrastive loss includes at least one of: a similar feature contrastive loss and a non-similar feature contrastive loss; wherein the similar feature contrastive loss includes at least one of: a first feature contrastive loss of the first sample image and the first decoded image, and a second feature contrastive loss of the second sample image and the second decoded image; and the non-similar feature contrastive loss includes at least one of: a third feature contrastive loss of the first sample image and the second decoded image, and a fourth feature contrastive loss of the second sample image and the first decoded image.

The processing flow of each module in the apparatus and the interaction flow between modules are described with reference to the relevant description in the above method embodiment, which will not be described in detail here.

The embodiment of the present disclosure further provides a computer device, as shown in FIG. 11, which is a schematic structural diagram of a computer device according to the embodiment of the present disclosure. The computer device includes:
a processor 10 and a memory 20. The memory 20 stores machine-readable instructions executable by the processor 10. The processor 10 is configured to execute the machine-readable instructions stored in the memory 20. When the machine-readable instructions are executed by the processor 10, the processor 10 executes the following steps:
acquiring a first image feature obtained by extracting a first feature from a first image and a second image feature obtained by extracting a second feature from a second image, wherein the image type of the first image is different from that of the second image; determining feature selection weights respectively corresponding to the first image feature and the second image feature based on the first image feature and the second image feature; performing feature fusion on the first image feature and the second image feature based on the feature selection weights respectively corresponding to the first image feature and the second image feature, to obtain fused feature data; and performing object detection processing based on the fused feature data to obtain an object detection result.

The memory 20 includes an internal memory 210 and an external memory 220. The internal memory 210 here is also referred to as a main memory, which is configured to temporarily store the operation data in the processor 10 and the data exchanged with an external memory 220 such as a hard disk. The processor 10 exchanges data with the external memory 220 through the internal memory 210.

The specific execution process of the above instructions can refer to the steps of the image processing method described in the embodiment of the present disclosure, which will not be described in detail here.

The embodiment of the present disclosure further provides a computer-readable storage medium, wherein the computer-readable storage medium stores a computer program, and the computer program, when being run by a processor, executes the steps of the image processing method described in the above method embodiment. The storage medium may be a volatile or nonvolatile computer-readable storage medium.

The embodiment of the present disclosure further provides a computer program product, which carries a program code. The program code includes instructions that can be used to execute the steps of the image processing method described in the above method embodiment. Refer to the above method embodiment for details, which will not be described in detail here.

The above computer program product can be implemented by hardware, software or the combination thereof. In an alternative implementation, the computer program product is embodied as a computer storage medium. In another alternative implementation, the computer program product is embodied as a software product, such as a Software Development Kit (SDK), etc.

It can be clearly understood by those skilled in the art that for the convenience and conciseness of description, the specific working process of the system and the apparatus described above can refer to the corresponding process in the above method embodiment, which will not be described in detail here. In several embodiments provided by the present disclosure, it should be understood that the disclosed system, the apparatus and the method can be implemented in other ways. The apparatus embodiment described above is only schematic. For example, the division of the units is only a logical function division, and there may be another division method in actual implementation. For another example, a plurality of units or components may be combined or integrated into another system, or some features may be ignored or not implemented. On the other hand, the mutual coupling or direct coupling or communication shown or discussed can be indirect coupling or communication through some communication interfaces, apparatuses or units, which can be in electrical, mechanical or other forms.

The units described as separate components may or may not be physically separated. The components displayed as units may or may not be physical units, that is, the components may be located in one place or distributed to a plurality of network units. Some or all of the units can be selected according to actual needs to achieve the purpose of the solution of this embodiment.

In addition, each function unit in each embodiment of the present disclosure may be integrated into one processing unit, or each unit may exist physically alone, or two or more units may be integrated into one unit.

If the functions are implemented in the form of software function units and sold or used as independent products, the functions can be stored in a nonvolatile computer-readable storage medium executable by a processor. Based on this understanding, the technical solution of the present disclosure, in essence, or the part that contributes to the prior art, or the part of the technical solution, can be embodied in the form of a software product. The computer software product is stored in a storage medium and includes several instructions to allow a computer device (which can be a personal computer, a server, a network device, etc.) to execute all or part of the steps of the method described in various embodiments of the present disclosure. The above storage medium includes a USB Flash Drive, a mobile hard disk, a Read-Only Memory (ROM), a Random Access Memory (RAM), a magnetic disk or an optical disk and other media that can store program codes.

Finally, it should be explained that the above embodiments are only specific implementations of the present disclosure, which are used to illustrate the technical solution of the present disclosure, rather than limit the technical solution. The scope of protection of the present disclosure is not limited thereto. Although the present disclosure has been described in detail with reference to the above embodiments, it should be understood by those skilled in the art that any person skilled in the art who is familiar with the technical field can still modify or easily conceive of changes to the technical solution described in the above embodiments within the technical scope disclosed in the present disclosure, or make equivalent replacements for some of the technical features. However, these modifications, changes or replacements, which do not make the essence of the corresponding technical solution deviate from the spirit and scope of the technical solution of the embodiment of the present disclosure, should be included in the scope of protection of the present disclosure. Therefore, the scope of protection of the present disclosure should be based on the scope of protection of the claims.

What is claimed is:

1. An image processing method, comprising:
acquiring a first image feature obtained by extracting a first feature from a first image and a second image feature obtained by extracting a second feature from a second image, wherein an image type of the first image is different from an image type of the second image;
determining feature selection weights respectively corresponding to the first image feature and the second image feature based on the first image feature and the second image feature;
performing feature fusion on the first image feature and the second image feature based on the feature selection weights respectively corresponding to the first image feature and the second image feature to obtain fused feature data; and
performing object detection processing based on the fused feature data to obtain an object detection result.

2. The image processing method according to claim 1, wherein the step of acquiring the first image feature obtained by extracting the first feature from the first image and the second image feature obtained by extracting the second feature from the second image comprises:
acquiring the first image and the second image; and
for any one of images, performing convolution processing on the image, and performing squeeze-and-excitation processing on a result obtained after convolution processing to obtain an image feature corresponding to the image.

3. The image processing method according to claim 1, wherein the step of determining the feature selection weights respectively corresponding to the first image feature and the second image feature based on the first image feature and the second image feature comprises:
performing first feature fusion processing on the first image feature and the second image feature to obtain an initial fused feature;
determining a feature importance vector for the first image feature and the second image feature based on the initial fused feature; and
determining the feature selection weights respectively corresponding to the first image feature and the second image feature by using the feature importance vector.

4. The image processing method according to claim 3, wherein the step of determining the feature importance vector for the first image feature and the second image feature based on the initial fused feature comprises:
performing global pooling processing on the initial fused feature to obtain an intermediate fused feature; and
performing full connection processing on the intermediate fused feature, and performing normalization processing on the intermediate fused feature after the full connection processing to obtain the feature importance vector.

5. The image processing method according to claim 3, wherein the step of determining the feature selection weights respectively corresponding to the first image feature and the second image feature by using the feature importance vector comprises:
determining the feature selection weights respectively corresponding to the first image feature and the second image feature based on the feature importance vector, the first image feature and the second image feature.

6. The image processing method according to claim 1, wherein the step of performing the feature fusion on the first image feature and the second image feature based on the feature selection weights respectively corresponding to the first image feature and the second image feature to obtain the fused feature data comprises:
performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and
performing second feature fusion processing on the first selected feature data and the second selected feature data to obtain the fused feature data.

7. The image processing method according to claim 1, wherein the image processing method is applied to a pre-trained network; and wherein the pre-trained network comprises a feature encoder, a feature reweighting device, and an object detector; wherein
the feature encoder is configured to acquire the first image feature obtained by extracting the first feature from the first image and the second image feature obtained by extracting the second feature from the second image, wherein the image type of the first image is different from the image type of of the second image;
the feature reweighting device is configured to determine the feature selection weights respectively corresponding to the first image feature and the second image feature based on the first image feature and the second image feature; and perform the feature fusion on the first image feature and the second image feature based on the feature selection weights respectively corresponding to the first image feature and the second image feature to obtain the fused feature data; and
the object detector is configured to perform the object detection processing based on the fused feature data to obtain the object detection result.

8. The image processing method according to claim 7, wherein the feature encoder and the feature reweighting device are obtained by training in following manner:
acquiring a first sample image and a second sample image, wherein an image type of the first sample image is different from an image type of the second sample image;
extracting a first feature from the first sample image by using a feature encoder to be trained to obtain a first sample feature; and extracting a second feature from the second sample image by using the feature encoder to be trained to obtain a second sample feature;
determining sample feature selection weights respectively corresponding to the first sample feature and the second sample feature by using a feature reweighting device to be trained, and performing the feature fusion on the first sample feature and the second sample feature based on the sample feature selection weights respectively corresponding to the first sample feature and the second sample feature to obtain sample fused feature data;
performing first decoding processing and second decoding processing on the sample fused feature data by using a feature decoder to obtain a first decoded image corresponding to the first sample image and a second decoded image corresponding to the second sample image; and
determining a feature contrastive loss based on the first sample image, the second sample image, the first decoded image, and the second decoded image; and updating the feature encoder to be trained and the feature reweighting device to be trained based on the feature contrastive loss to obtain the feature encoder and the feature reweighting device.

9. The image processing method according to claim 8, wherein the feature contrastive loss comprises at least one of a similar feature contrastive loss and a non-similar feature contrastive loss; wherein
the similar feature contrastive loss comprises at least one of: a first feature contrastive loss of the first sample image and the first decoded image, and a second feature contrastive loss of the second sample image and the second decoded image; and
the non-similar feature contrastive loss comprises at least one of: a third feature contrastive loss of the first sample image and the second decoded image, and a fourth feature contrastive loss of the second sample image and the first decoded image.

10. An image processing apparatus, comprising:
an acquisition module, configured to acquire a first image feature obtained by extracting a first feature from a first image and a second image feature obtained by extracting a second feature from a second image, wherein an image type of the first image is different from an image type of the second image;
a determining module, configured to determine feature selection weights respectively corresponding to the first image feature and the second image feature based on the first image feature and the second image feature;
a feature fusion module, configured to perform feature fusion on the first image feature and the second image feature based on the feature selection weights respectively corresponding to the first image feature and the second image feature to obtain fused feature data; and
a processing module, configured to perform object detection processing based on the fused feature data to obtain an object detection result.

11. A computer device, comprising:
a processor; and
a memory, wherein machine-readable instructions are stored in the memory and executable by the processor;
wherein the processor is configured to execute the machine-readable instructions stored in the memory, and when the machine-readable instructions are executed by the processor, the processor implements steps of an image processing method;
wherein the image processing method comprises
acquiring a first image feature obtained by extracting a first feature from a first image and a second image feature obtained by extracting a second feature from a second image, wherein an image type of the first image is different from an image type of the second image;
determining feature selection weights respectively corresponding to the first image feature and the second image feature based on the first image feature and the second image feature;
performing feature fusion on the first image feature and the second image feature based on the feature selection weights respectively corresponding to the first image feature and the second image feature to obtain fused feature data; and
performing object detection processing based on the fused feature data to obtain an object detection result.

12. A non-transitory computer-readable storage medium, having a computer program stored therein, and when the computer program is run by a computer device, the computer device implements steps of the image processing method according to claim 1.

13. The image processing method according to claim 2, wherein the step of determining the feature selection weights respectively corresponding to the first image feature and the second image feature based on the first image feature and the second image feature comprises:
performing first feature fusion processing on the first image feature and the second image feature to obtain an initial fused feature;
determining a feature importance vector for the first image feature and the second image feature based on the initial fused feature; and
determining the feature selection weights respectively corresponding to the first image feature and the second image feature by using the feature importance vector.

14. The image processing method according to claim 4, wherein the step of determining the feature selection weights respectively corresponding to the first image feature and the second image feature by using the feature importance vector comprises:
determining the feature selection weights respectively corresponding to the first image feature and the second image feature based on the feature importance vector, the first image feature and the second image feature.

15. The image processing method according to claim 2, wherein the step of performing the feature fusion on the first image feature and the second image feature based on the feature selection weights respectively corresponding to the first image feature and the second image feature to obtain the fused feature data comprises:
performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and
performing second feature fusion processing on the first selected feature data and the second selected feature data to obtain the fused feature data.

16. The image processing method according to claim 3, wherein the step of performing the feature fusion on the first image feature and the second image feature based on the feature selection weights respectively corresponding to the first image feature and the second image feature to obtain the fused feature data comprises:
performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and
performing second feature fusion processing on the first selected feature data and the second selected feature data to obtain the fused feature data.

17. The image processing method according to claim 4, wherein the step of performing the feature fusion on the first image feature and the second image feature based on the feature selection weights respectively corresponding to the first image feature and the second image feature to obtain the fused feature data comprises:
performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and
performing second feature fusion processing on the first selected feature data and the second selected feature data to obtain the fused feature data.

18. The image processing method according to claim 5, wherein the step of performing the feature fusion on the first image feature and the second image feature based on the feature selection weights respectively corresponding to the first image feature and the second image feature to obtain the fused feature data comprises:
performing feature selection on the first image feature based on a feature selection weight corresponding to the first image feature to obtain first selected feature data of the first image feature; and performing the feature selection on the second image feature by using a feature selection weight corresponding to the second image feature to obtain second selected feature data of the second image feature; and
performing second feature fusion processing on the first selected feature data and the second selected feature data to obtain the fused feature data.

19. The image processing method according to claim 2, wherein the image processing method is applied to a pre-trained network; and wherein the pre-trained network comprises a feature encoder, a feature reweighting device, and an object detector; wherein
the feature encoder is configured to acquire the first image feature obtained by extracting the first feature from the first image and the second image feature obtained by extracting the second feature from the second image, wherein the image type of the first image is different from the image type of the second image;
the feature reweighting device is configured to determine the feature selection weights respectively corresponding to the first image feature and the second image feature based on the first image feature and the second image feature; and perform the feature fusion on the first image feature and the second image feature based on the feature selection weights respectively corresponding to the first image feature and the second image feature to obtain the fused feature data; and
the object detector is configured to perform the object detection processing based on the fused feature data to obtain the object detection result.

20. The image processing method according to claim 3, wherein the image processing method is applied to a pre-trained network; and wherein the pre-trained network comprises a feature encoder, a feature reweighting device, and an object detector; wherein
the feature encoder is configured to acquire the first image feature obtained by extracting the first feature from the first image and the second image feature obtained by extracting the second feature from the second image, wherein the image type of the first image is different from the image type of the second image;
the feature reweighting device is configured to determine the feature selection weights respectively corresponding to the first image feature and the second image feature based on the first image feature and the second image feature; and perform the feature fusion on the first image feature and the second image feature based on the feature selection weights respectively corresponding to the first image feature and the second image feature to obtain the fused feature data; and
the object detector is configured to perform the object detection processing based on the fused feature data to obtain the object detection result.
